(19) United States
(12) Patent Application Publication
(10) Pub. No.: US 2026/0220861 A1
(43) Pub. Date: Jul. 30, 2026

(54) Platform for Mobile-to-Installation Interactive and Spatial Storytelling

(71) Applicant: Meow Wolf Inc., Santa Fe, NM (US)

(72) Inventors: John Lee, Palo Alto, CA (US); Tasia Miles, Colorado Springs, CO (US)

(21) Appl. No.: 19/463,817

(22) Filed: Jan. 29, 2026

Related U.S. Application Data
(60) Provisional application No. 63/751,470, filed on Jan. 30, 2025.

(51) Int. Cl. G06T 13/00; G06F 3/0481; G06Q 10/087

(52) U.S. Cl. CPC G06T 13/00; G06Q 10/087; G06F 3/0481; G06T 2200/24

(57) ABSTRACT

A method includes determining a signal strength value associated with a wireless signal emitted by a beacon disposed within a physical exhibition space. The method includes determining a proximity score based on the signal strength value and an environmental calibration parameter. The environmental calibration parameter is configured to compensate for signal attenuation caused by an environmental feature proximate to the beacon. The method includes determining that the determined proximity score satisfies an interaction threshold defined for the environmental feature. Based on determining that the interaction threshold is satisfied, the method includes modifying a digital inventory record associated with a user account to transition a content collection item corresponding to the environmental feature from a locked state to an unlocked state. The method includes generating a notification configured to be displayed on a graphical user interface (GUI) of a mobile device. The notification indicates discovery of the content collection item.

### CROSS REFERENCE TO RELATED APPLICATION

The present application claims the filing benefits of U.S. provisional application Ser. No. 63/751,470, filed Jan. 30 , 2025, which is hereby incorporated herein by reference in its entirety.

### BACKGROUND

Mobile applications are increasingly utilized in physical environments, such as museums, retail stores, and entertainment venues, to augment the visitor experience with digital content. These applications often serve to bridge the physical and digital worlds, providing users with information, narrative elements, or incentives based on their location within a space. For example, a visitor to a museum might use a mobile device to access an audio guide relevant to a specific exhibit, or a shopper might receive a notification regarding a promotion upon entering a specific department of a store.

Conventional approaches for delivering location-based content typically rely on active user engagement mechanisms. A common implementation involves the use of visual markers, such as Quick Response (QR) codes or specific images placed on walls or objects. To access content, a user must physically locate the marker, retrieve their mobile device, launch an application or camera, and aim the device at the marker to scan it. This process requires the user to halt their exploration of the physical environment and shift their focus entirely to the mechanics of the mobile device interaction.

Other systems utilize passive location detection technologies, such as Bluetooth Low Energy (BLE) beacons or Wi-Fi signal triangulation, to trigger content without requiring a scan. These systems generally rely on measuring the Received Signal Strength Indicator (RSSI) to estimate the distance between the user's device and a transmitter. These implementations are often designed for large, open environments with standard construction materials, such as retail “big box” stores or office buildings. In these settings, the systems are typically configured to determine if a user has entered a broad zone or room, rather than determining proximity to a specific object within that room.

### SUMMARY

One aspect of the disclosure provides a computer-implemented method executed by data processing hardware of a mobile device that causes the data processing hardware to perform operations. The operations include determining a signal strength value associated with a wireless signal emitted by a beacon disposed within a physical exhibition space. The operations also include determining a proximity score based on the signal strength value and an environmental calibration parameter, the environmental calibration parameter configured to compensate for signal attenuation caused by an environmental feature proximate to the beacon. The operations further include determining that the determined proximity score satisfies an interaction threshold defined for the environmental feature. The operations also include, based on determining that the interaction threshold is satisfied, modifying a digital inventory record associated with a user account to transition a content collection item corresponding to the environmental feature from a locked state to an unlocked state. The operations further include generating a notification configured to be displayed on a graphical user interface (GUI) of the mobile device, the notification indicating discovery of the content collection item.

Implementations of the disclosure may include one or more of the following optional features. In some implementations, the mobile device executes an application associated with the digital inventory record in a background state, such that the modification of the digital inventory record occurs without requiring user interaction with the GUI at a time of discovery. Determining the proximity score may include receiving signal strength values from a plurality of beacons disposed within the physical exhibition space and triangulating a position of the mobile device relative to the environmental feature. In these implementations, the environmental calibration parameter includes an attenuation factor corresponding to a metallic composition of the environmental feature.

In some examples, the operations further include receiving an indication of a secondary user interaction associated with the environmental feature, and wherein modifying the digital inventory record is based on receiving the indication of the secondary user interaction. The indication of the secondary user interaction may include determining that the mobile device has detected an audio signature emitted by the environmental feature. In some implementations, the operations further include determining that the mobile device has exited a geographical area associated with the physical exhibition space and based on determining that the mobile device has exited the geographical area associated with the physical exhibition space, enabling access to a post-visit subset of the content collection item, the post-visit subset comprising a chronological narrative playlist.

Modifying the digital inventory record may be further based on determining that the digital inventory record includes a requisite precursor item. In some examples, the beacon is coupled to a mobile entity moving through the physical exhibition space and the interaction threshold is dynamically satisfied based on a changing location of the mobile entity relative to the mobile device. In other examples, the operations further include receiving a confirmation signal from a sensor located at the environmental feature, the confirmation signal indicating presence of a physical token associated with the user account at the environmental feature, and modifying the digital inventory record is performed further based on receiving the confirmation signal.

In some implementations, the GUI includes a home screen interface having a plurality of icons, wherein the operations further include detecting an orientation of the mobile device and based on the detected orientation of the mobile device, animating a movement of the plurality of icons on the home screen using a simulated gravitational force parameter.

Another aspect of the disclosure provides a system including data processing hardware and memory hardware in communication with the data processing hardware. The memory hardware stores instructions that when executed on the data processing hardware cause the data processing hardware to perform operations. The operations include determining a signal strength value associated with a wireless signal emitted by a beacon disposed within a physical exhibition space. The operations also include determining a proximity score based on the signal strength value and an environmental calibration parameter, the environmental calibration parameter configured to compensate for signal attenuation caused by an environmental feature proximate to the beacon. The operations further include determining that the determined proximity score satisfies an interaction threshold defined for the environmental feature. The operations also include, based on determining that the interaction threshold is satisfied, modifying a digital inventory record associated with a user account to transition a content collection item corresponding to the environmental feature from a locked state to an unlocked state. The operations further include generating a notification configured to be displayed on a graphical user interface (GUI) of the mobile device, the notification indicating discovery of the content collection item.

This aspect may include one or more of the following optional features. In some implementations, the mobile device executes an application associated with the digital inventory record in a background state, such that the modification of the digital inventory record occurs without requiring user interaction with the GUI at a time of discovery. Determining the proximity score may include receiving signal strength values from a plurality of beacons disposed within the physical exhibition space and triangulating a position of the mobile device relative to the environmental feature. In these implementations, the environmental calibration parameter includes an attenuation factor corresponding to a metallic composition of the environmental feature.

In some examples, the operations further include receiving an indication of a secondary user interaction associated with the environmental feature, and wherein modifying the digital inventory record is based on receiving the indication of the secondary user interaction. The indication of the secondary user interaction may include determining that the mobile device has detected an audio signature emitted by the environmental feature. In some implementations, the operations further include determining that the mobile device has exited a geographical area associated with the physical exhibition space and based on determining that the mobile device has exited the geographical area associated with the physical exhibition space, enabling access to a post-visit subset of the content collection item, the post-visit subset comprising a chronological narrative playlist.

Modifying the digital inventory record may be further based on determining that the digital inventory record includes a requisite precursor item. In some examples, the beacon is coupled to a mobile entity moving through the physical exhibition space and the interaction threshold is dynamically satisfied based on a changing location of the mobile entity relative to the mobile device. In other examples, the operations further include receiving a confirmation signal from a sensor located at the environmental feature, the confirmation signal indicating presence of a physical token associated with the user account at the environmental feature, and modifying the digital inventory record is performed further based on receiving the confirmation signal.

In some implementations, the GUI includes a home screen interface having a plurality of icons, wherein the operations further include detecting an orientation of the mobile device and based on the detected orientation of the mobile device, animating a movement of the plurality of icons on the home screen using a simulated gravitational force parameter.

### DESCRIPTION OF DRAWINGS

FIG. 1 is a schematic view of an example location-based content delivery system.

FIG. 2 is a flowchart of an example arrangement of operations for executing a location-based content delivery and unlocking process.

FIG. 3 is a schematic view of an example proximity engine configured to calculate a calibrated proximity score.

FIG. 4 is a schematic view of an example physics configuration interface for adjusting simulated physical parameters of a user interface.

FIG. 5 is a schematic view of an example home screen interface displaying icons subject to simulated gravitational forces.

FIG. 6 is a flowchart of an example arrangement of operations for a method of determining location-based proximity using environmental calibration.

FIG. 7 is a block diagram of an example computing device that may be used to implement the systems and methods described herein.

Like reference symbols in the various drawings indicate like elements.

### DETAILED DESCRIPTION

Integrating digital narratives and content into physical environments, such as art exhibitions, museums, or immersive venues, presents distinct challenges regarding user engagement and immersion. Some implementations rely on visual markers, such as Quick Response (QR) codes or specific glyphs, located throughout the physical space. To access associated digital content, a user must actively locate these markers, retrieve their mobile device, unlock it, launch a camera or scanning application, and physically aim the device at the target. This sequence of operations forces the user to disengage from the physical environment and the narrative flow, effectively shifting their role from an explorer of the space to an operator of a device. This friction disrupts the immersive nature of the experience, creating a barrier between the physical art and the digital layer intended to augment it.

Alternative approaches utilize passive radio frequency (RF) technologies, such as Bluetooth Low Energy (BLE) beacons, to approximate user location without requiring visual scans. However, standard implementations of these technologies are typically designed for environments with predictable signal propagation characteristics, such as retail stores constructed with standard drywall and open aisles. In contrast, immersive exhibition spaces are often comprised of irregular geometries, high-density layouts, and varying construction materials. Specifically, art installations often utilize materials that significantly interfere with RF signals, such as large metal sculptures, steel mesh, or dense composite structures. These materials cause signal attenuation, reflection, and multipath propagation, rendering standard proximity detection algorithms unreliable.

Consequently, mobile devices relying on raw signal strength indicators (RSSI) in these complex environments frequently fail to accurately determine proximity. A device might detect a weak signal and erroneously conclude that the user is distant from an object, when in reality, the user is standing directly in front of an installation that is physically blocking or dampening the signal. Existing systems lack the environmental awareness to compensate for these material-specific interference patterns. This lack of precision limits the ability of such systems to trigger content based on granular interactions, forcing developers to rely on broad “room-level” detection rather than object-specific proximity, thereby reducing the personalization and relevance of the digital experience.

The systems and methods described herein address these and other limitations by implementing a location-based content delivery system that executes a background scanning process to detect wireless signals emitted by beacons disposed within the physical space. Rather than relying solely on raw signal strength, the system determines or calculates a proximity score by applying an environmental calibration parameter to the detected signal values. This calibration parameter is specifically configured to compensate for signal attenuation caused by the physical composition or geometry of the environmental feature (e.g., a metal art installation) proximate to the beacon. By algorithmically adjusting for the specific interference characteristics of the feature, the system can distinguish between general proximity and specific interaction thresholds with precision.

Upon determining that the calibrated proximity score satisfies the specific interaction threshold, the system automatically modifies a digital inventory record associated with the user account. This transitions content collection items (e.g., narrative text, audio, video, or “memories”) from a locked state to an unlocked state. This process occurs passively in the background, allowing the user to collect a “digital inventory” of their experience without needing to actively manipulate the device. A notification is generated on the graphical user interface only when a discovery is made, prompting the user to engage with the content at their convenience rather than demanding immediate attention.

The disclosed technology provides technical advantages and improvements to the functioning of mobile computing devices operating in complex RF environments. By integrating environmental calibration parameters that account for physical signal attenuation (e.g., metallic interference), the system improves the accuracy of wireless signal processing and location determination. This transforms the mobile device from a generic receiver into a precision sensor capable of operating reliably in environments where some location services would fail. Additionally, by executing these checks in a background state and removing the need for camera-based scanning, the system optimizes device power consumption and processing resources while maintaining a continuous state of readiness. These features collectively enable a seamless integration of digital and physical realities, preserving user immersion while ensuring reliable content delivery.

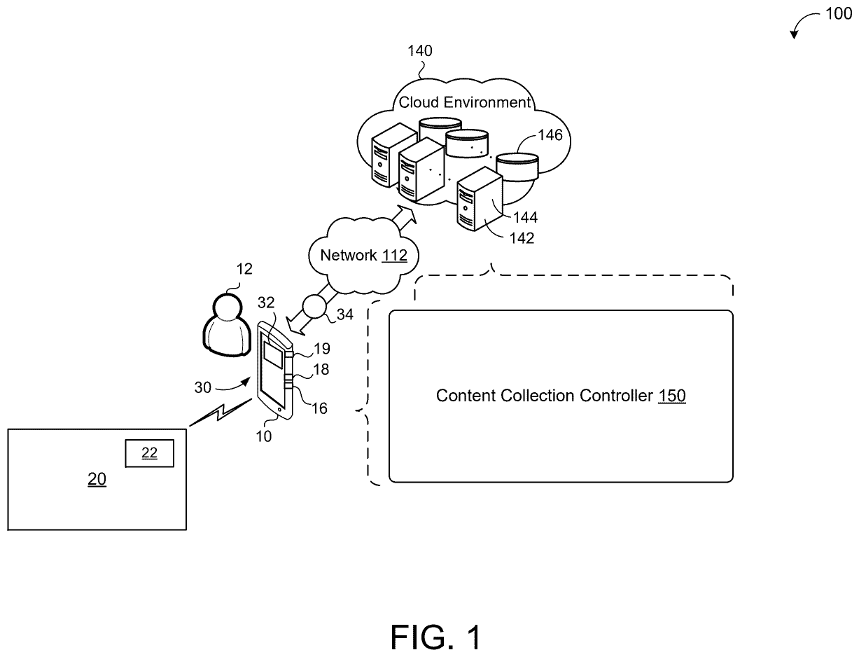

Referring to FIG. 1, in some implementations, a location-based content delivery system 100 includes a mobile user device 10 associated with a user 12 located within a physical exhibition space (e.g., an immersive art installation, a museum, or a narrative environment). The user device 10 communicates with a remote system 140 via a network 112, such as the Internet, a local area network (LAN), or a specific guest Wi-Fi network provided within the exhibition space. The remote system 140 may be a distributed cloud environment having scalable resources 142, including computing resources 144 (e.g., servers, data processing hardware) and storage resources 146 (e.g., databases, memory hardware). A user account data store 148 may be maintained on the storage resources 146 to synchronize progress, inventory, and logic states across multiple sessions or devices.

The user device 10 is a portable computing device, such as a smartphone, tablet, or wearable device, carried by the user 12 as they explore the physical environment. The user device 10 includes data processing hardware 18 (e.g., a CPU, GPU) and memory hardware 16. The user device 10 also includes a suite of device sensors 19 configured to capture environmental data. These device sensors 19 include a wireless transceiver (e.g., Bluetooth Low Energy (BLE), Ultra-Wideband (UWB), or Wi-Fi RTT), an inertial measurement unit (IMU) containing accelerometers and gyroscopes, and a microphone. The data processing hardware 18 executes a graphical user interface (GUI) 30 displayed on a screen of the user device 10. The GUI 30 provides the visual interface for an operating system, such as a simulated operating system environment that acts as a narrative companion to the physical space.

In some implementations, the simulated operating system environment functions as a modular applet framework. The system acts as a wrapper for distinct “Applets” (mini-applications) that may be added, removed, or updated remotely via a Content Management System (CMS), allowing the narrative content to evolve without requiring full software updates. To further deepen the immersion, the GUI 30 may include system-wide theming and “Easter Egg” settings. For example, the user 12 may toggle system-wide font settings to change the textual presentation of the application from standard English to fictional languages or fonts associated with the narrative lore (e.g., “Eemian,” “Snurtle,” or “Zenion”). These cosmetic overrides allow the user device 10 to simulate the appearance of alien technology or an interdimensional artifact.

The physical exhibition space is populated with various environmental features 20. An environmental feature 20 represents a specific physical object, art installation, room, or architectural element within the space. For example, the environmental feature 20 might be a mailbox, a vintage computer terminal, a large metal sculpture of a creature, or a hidden door. Embedded within or proximate to the environmental feature 20 is a beacon 22. The beacon 22 is a hardware transmitter, such as a battery-operated BLE beacon configured for long-life battery management (e.g., having an operational lifespan of 5-10 years), that broadcasts a wireless signal 24 continuously or at set intervals. Technical operations personnel may monitor the lifecycle of the beacon 22 to ensure continuous functionality. The beacon 22 is typically hidden from view (e.g., inside the casing of a mailbox or behind a wall panel) to maintain the immersive aesthetic of the art.

A content collection controller 150 manages the logic for bridging the physical world (the feature 20) and the digital world (the user device 10). The content collection controller 150 may be implemented as a software module executing locally on the data processing hardware 18 of the user device 10, as a service running on the remote system 140, or as a hybrid system where real-time signal processing occurs on the device 10 while state synchronization occurs in the cloud 140. In the example described herein, the content collection controller 150 operates primarily on the user device 10 to ensure low-latency responsiveness even if network connectivity 112 is intermittent.

The content collection controller 150 is configured to execute a background scanning process. This allows the user device 10 to detect the wireless signal 24 emitted by the beacon 22 even when the user device 10 is in a “passive” state (e.g., locked in the user's pocket or with the app running in the background). This passive engagement model distinguishes the system 100 from active scanning systems like QR codes, which require the user 12 to actively retrieve and aim the device 10.

While the system operates primarily in a passive background mode, the GUI 30 also provides an “Active Mode” visualization for the user 12 who chooses to actively view the scanning process. In this active state, the scanning operation may be visualized as a specific animation, such as a “Rainbow Swirl,” indicating that the “Psychic Sensor” is actively searching for signals. Furthermore, the GUI 30 is configured to present intuitive error states if the scanning process is impeded. For instance, if the user device 10 lacks the necessary permissions (e.g., Bluetooth, Location Services, or Notification permissions are disabled), the GUI 30 displays a specific visual indicator, such as a “Sad Face” icon or a “Red X,” to promptly alert the user 12 to the configuration issue.

When the user device 10 detects a wireless signal 24, the content collection controller 150 determines a signal strength value (e.g., RSSI) associated with that signal. However, in complex exhibition spaces, raw signal strength is often unreliable due to interference. For instance, if the environmental feature 20 is a large metallic sculpture or a mesh tunnel, the metal materials may reflect, absorb, or attenuate the wireless signal 24, causing the device 10 to believe it is far away from the feature 20 when the user 12 is actually standing right in front of it. To address this, the content collection controller 150 applies an environmental calibration parameter to the received signal data.

The environmental calibration parameter is a specific data value or algorithm modification linked to the specific beacon 22 or feature 20 that compensates for the physical geometry and material composition of the immediate surroundings. For example, the controller 150 may apply a specific gain offset, a signal smoothing filter, or a triangulation algorithm that utilizes signals from multiple nearby beacons 22 to verify the user's position despite the attenuation caused by the feature 20. By processing the raw signal strength against this calibration parameter, the controller 150 calculates a high-fidelity proximity score.

The content collection controller 150 compares this proximity score against a defined interaction threshold. Different features 20 may have different thresholds. For example, a “General Proximity” threshold might simply register that the user 12 is in the room, while a “Interaction Proximity” threshold requires the user 12 to be within a few inches of a specific object (e.g., holding their phone up to the beacon 22 inside a safe).

When the proximity score satisfies the interaction threshold, the content collection controller 150 triggers an unlock event. This involves modifying a digital inventory record 160 stored in the memory 16 (and synchronized to the user account 148 via data path 34). The digital inventory record 160 tracks the user's collection of narrative items. Upon a successful trigger, a specific content collection item (e.g., a video clip, a text log, an audio diary, or an artist interview corresponding to the environmental feature 20) is transitioned from a “locked” (hidden or silhouetted) state to an “unlocked” (accessible) state.

Upon unlocking the content, the content collection controller 150 generates a notification 32. The notification 32 is a visual or audible or haptic alert presented on the GUI 30 (or lock screen) of the user device 10. For instance, an AI agent character (e.g., “Alva”) within the app might send a push notification saying, “You found a Psychic Trace! Check your inventory.” This prompts the user 12 to engage with the digital content 34 at their leisure, rather than forcing immediate viewing.

In some implementations, the content collection controller 150 requires more than just proximity to unlock content. These scenarios utilize secondary user interactions that require the user 12 to perform a physical action in the real world to trigger the digital unlock. For example, the environmental feature 20 might be a physical pipe organ. To unlock the content, the user 12 must play a specific melody on the organ. The device sensors 19 (microphone) detect the specific audio signature (the melody) emitted by the feature 20. In other examples, the user 12 must enter a specific code (e.g., “777”) on a physical jukebox to unlock music tracks, or interact with a studio computer interface to access a hidden directory (e.g., “Rhombus' Secret Stash”). Additional physical-digital hybrid triggers may involve the user 12 physically collapsing a stacking camel sculpture, activating a physical switch on a control panel in a “Lightning Room,” or opening a specific desk drawer in a “Foreman's Office” to trigger a security camera effect. The controller 150 combines the proximity score (confirming the user is at the object) with the secondary verification (e.g., audio recognition, keypad entry, or hardware sensor data) to modify the digital inventory record 160.

The system 100 also supports dynamic or moving targets. In this scenario, the beacon 22 is not fixed to a static environmental feature 20 but is instead coupled to a mobile entity 180. As the mobile entity 180 moves through the space, the “interaction threshold” effectively moves with them. The user 12 must locate the specific character to satisfy the proximity requirements, turning the experience into a live scavenger hunt.

The GUI 30 also includes a “physics engine” driven by the device sensors 19 (accelerometer/gyroscope). The icons representing different applets (mini-applications within the operating system) on the home screen may not be static. For example, they may move, slide, and collide based on the physical orientation of the user device 10. The content collection controller 150 determines or calculates a simulated gravitational force based on the device tilt and applies it to the UI elements, reinforcing the concept of the app as a “Multiversal Multitool” that reacts to the physical world.

In addition to location-specific functionalities, the system 100 includes a suite of remote interaction modules, referred to as “Multiverse” applets, accessible regardless of the user's physical proximity to the exhibition space. These modules may include a simulated telephony interface including a directory of fictional residents. Optionally, the interface accepts user inputs to “dial” specific numbers, triggering playback of pre-recorded narrative loops or voicemail statuses. Another module may render high-resolution, zoomable two-dimensional artwork and detects pan and zoom gestures to verify the location of hidden items within the canvas. The system may also execute a module that renders a randomized sequence of experimental video content representing “debris” from the multiverse, and a module functioning as an internet radio player with exhibit-specific audio and potential alternate reality game (ARG) components. Furthermore, a messaging interface may utilize a chatbot or Large Language Model (LLM) agent to simulate character interactions (e.g., with a character named “Dug”). This agent is context-aware, initiating communications based on the user's current location or story progress. Additional modules may include interactive digital sculptures that animate based on the screen gravity physics described herein, and a vertical-scroll digital reader for narrative comics.

In some implementations, the system 100 manages post-visit engagement and data analytics. The content collection controller 150 monitors the location of the user device 10 (via GPS or Wi-Fi visibility). When the controller 150 determines that the user 12 has physically exited the geographical area of the exhibition space, it enables access to a “Memories” subset of the collected content. This subset might organize the disjointed clips collected during the visit into a chronological narrative playlist, allowing the user 12 to understand the linear story of the exhibition only after they have completed their exploration. This logic allows the in-exhibit experience to remain non-linear and exploratory while providing narrative closure post-visit. Simultaneously, the system utilizes the collected data for marketing segmentation. Specific user behaviors (e.g., “Completed the sci-fi story arc”) are utilized to tag the user profile for targeted marketing campaigns or specific membership rewards. Additionally, the system may implement a session replay protocol, recording a sampling of user sessions (e.g., 1-in-10 sessions) to facilitate UX optimization and bug fixing.

The data shared via the data path 34 between the user device 10 and the cloud environment 140 ensures that the user's digital inventory is persistent. If the user 12 logs into a different device, or visits a different exhibition location (e.g., moving from a first city location to a second city location), the user account 148 retrieves their progress. This synchronization supports membership gating, where specific applets and content tiers are restricted based on the user's login status (e.g., Anonymous, Registered, or Paid Member). A “Portal Pass” feature may integrate a digital wallet for season pass holders, granting access to exclusive content tiers. This also enables “Logic Blockers,” where the content collection controller 150 checks the digital inventory record 160 for requisite precursor items (e.g., “Key A” found in Room 1) before allowing an unlock event in a different physical location (e.g., “Door B” in Room 2), effectively turning the physical space into a verifiable game state. Additionally, to facilitate cross-location promotion, the GUI 30 may include a preview interface (e.g., a dropdown menu within the Psychic Sensor) that allows the user 12 to toggle between different venue views (e.g., switching from the first city location to the second city location). This enables the user 12 to watch preview videos and purchase tickets for other venues directly within the application.

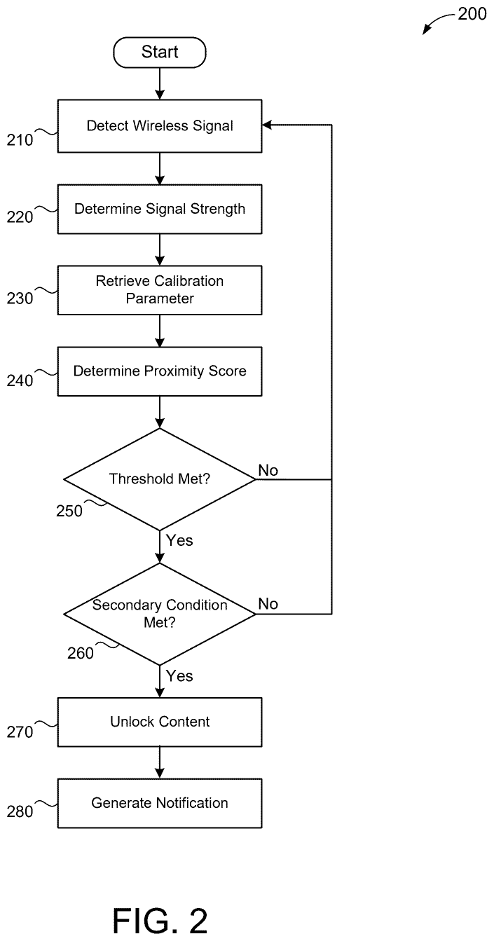

Referring now to FIG. 2, a flowchart illustrates an example method 200 for executing a location-based content delivery and unlocking process. The method 200 is executed by the data processing hardware 18 of the user device 10, specifically under the logical control of the content collection controller 150. While the steps are depicted in a linear sequence, in practical application, the content collection controller 150 may execute these operations as a continuous, background loop or service that remains active even when the mobile device 10 is locked or when the user 12 is interacting with a different application. This continuous execution ensures the passive nature of the discovery process, allowing the user 12 to focus on the physical environmental features 20 without constantly manipulating the screen of the device 10.

At operation 210, the content collection controller 150 detects a wireless signal 24 emitted by a beacon 22 via the wireless transceiver of the user device 10. The scanning process at operation 210 is optimized for complex radio frequency (RF) environments. Unlike standard retail beacon scanners that might scan infrequently to detect entry into a large zone, the operation 210 scans at a higher frequency to detect granular movements of the user 12 through dense art installations. The content collection controller 150 filters the detected signals to identify only those beacons 22 associated with specific exhibition identifiers, ignoring extraneous signals from other guests' devices or non-system hardware.

At operation 220, the content collection controller 150 determines a signal strength value associated with the detected wireless signal. This value is typically represented as a Received Signal Strength Indicator (RSSI) measured in decibels-milliwatts (dBm). In an ideal environment, RSSI correlates logarithmically with distance. However, the physical exhibition space is rarely an ideal RF environment, as it contains obstructions and art installations composed of varying materials that distort RF propagation. Relying solely on the raw RSSI value determined at step 220 would likely lead to false negatives where the user 12 is close but the signal is weak due to blockage, or false positives where signal reflection makes a distant beacon appear close.

To address these environmental irregularities, at operation 230, the content collection controller 150 retrieves an environmental calibration parameter. This parameter is a pre-determined data set stored in the memory 16 or cached from the cloud environment 140. Each beacon 22 or specific environmental feature 20 is mapped to a specific calibration profile. The environmental calibration parameter is configured to compensate for signal attenuation caused by the physical composition or geometry of the environmental feature 20 proximate to the beacon 22. For example, if an environmental feature 20 is a large, dense metal sculpture that naturally attenuates Bluetooth signals, the calibration parameter includes an attenuation factor or gain offset that instructs the controller 150 to boost the interpretation of the raw RSSI. This allows the system to correctly interpret a weak signal as a close proximity event in that specific context.

At operation 240, the content collection controller 150 determines a proximity score based on the raw signal strength value and the retrieved environmental calibration parameter. This proximity score represents a high-fidelity estimation of the distance between the user 12 and the feature 20. In some implementations, determining the proximity score involves triangulation, where the controller 150 receives signal strength values from a plurality of beacons 22 disposed within the space. The controller 150 utilizes the calibration parameters for all detected beacons to triangulate the position of the mobile device 10 relative to the target environmental feature 20, allowing the system to distinguish between a user 12 standing directly in front of an object and a user 12 standing on the other side of a thin wall.

At operation 250, the content collection controller 150 determines whether the calculated proximity score satisfies a specific interaction threshold defined for the environmental feature 20. The interaction threshold is variable and content-dependent.

For general proximity discoveries, such as entering a room to unlock a soundtrack, the threshold might be set loosely. For interaction proximity discoveries, such as inspecting a small detail on a desk, the threshold is set tightly. If the threshold is not met, the method 200 returns to operation 210 and continues scanning. This loop ensures that transient signals do not trigger unlocking events. The user 12 maintains the necessary proximity for the algorithm to stabilize.

If the threshold is met, the method proceeds to operation 260 to determine if a requisite secondary user interaction or logic state has been satisfied. While some content unlocks based purely on passive proximity, other narrative elements utilize a physical-digital hybrid trigger mechanism. Operation 260 transforms the physical space into a verified game state controller by requiring additional inputs beyond location.

In some implementations of operation 260, the secondary condition includes an audio signature verification. For example, if the environmental feature 20 is a musical instrument like a pipe organ, the secondary condition requires the user 12 to play a specific melody. The user device 10 activates its microphone to listen for a specific audio fingerprint. The content collection controller 150 determines the secondary condition is met only if the proximity score places the user at the organ and the microphone detects the correct melody. In other implementations, the secondary condition involves a physical code entry. If the feature 20 is a locked physical safe, the user 12 must find a physical code within the room and enter it into the safe's keypad or the GUI 30. The act of opening the safe triggers a sensor change or reveals an inner beacon 22, satisfying the condition.

The secondary condition at operation 260 may also involve digital logic blockers or inventory checks. The content collection controller 150 queries the digital inventory record 160 to ensure the user 12 possesses a requisite precursor item. For instance, a hidden door may not unlock in the app unless the user has previously collected a specific key item from a different location. Additionally, the beacon 22 may be attached to a mobile entity, such as a staff member. In this dynamic scenario, the secondary condition requires the user 12 to engage the staff member, prompting a manual release signal that combines with the Bluetooth proximity to validate the interaction. In yet another embodiment, the secondary condition involves a physical token held by the user 12. Placing an RFID-enabled token on a sensing shelf triggers a confirmation signal sent to the user device 10, satisfying the condition.

If the secondary condition is met, or if no secondary condition is required, the method proceeds to operation 270. At operation 270, the content collection controller 150 performs the unlock action by modifying the digital inventory record 160 associated with the user account. A specific content collection item corresponding to the environmental feature 20 is transitioned from a locked state to an unlocked state. This modification is persisted to the local memory 16 and synchronized to the cloud environment 140. Finally, at operation 280, the content collection controller 150 generates a notification 32 configured to be displayed on the GUI 30. This notification typically includes a haptic alert and/or sound to prompt the user 12 to view the newly discovered content, confirming that their physical actions have successfully triggered the digital narrative.

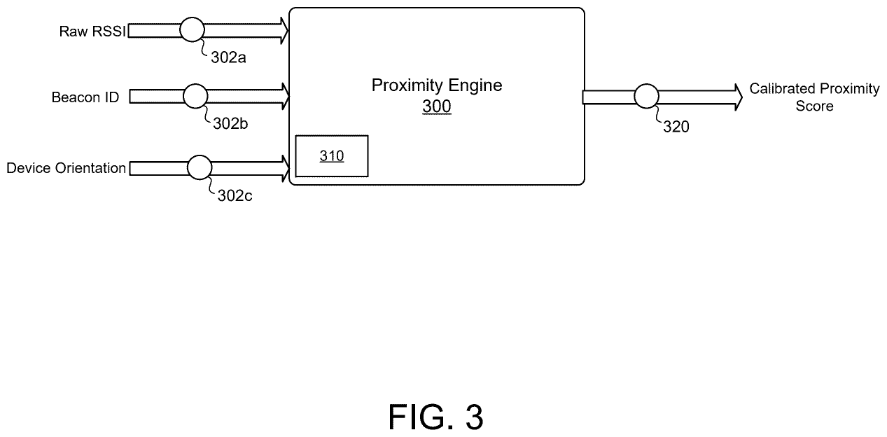

Referring now to FIG. 3, a schematic diagram illustrates the architecture of a proximity engine 300. The proximity engine 300 serves as the signal processing kernel within the content collection controller 150 (shown in FIG. 1). It is responsible for ingesting raw, noisy environmental data and transforming it into a stable, actionable metric used to trigger the unlocking of content. As discussed previously, the physical exhibition space presents a hostile radio frequency (RF) environment characterized by high-density layouts and signal-blocking artistic materials. The proximity engine 300 is specifically architected to mitigate these environmental factors through algorithmic calibration.

The proximity engine 300 receives a plurality of inputs 302a, 302b, 302c gathered by the device sensors 19 of the user device 10. The first input 302a comprises the Raw RSSI (Received Signal Strength Indicator). This is the immediate, unprocessed measure of the power level of the wireless signal 24 being received from a beacon 22. In a vacuum, RSSI degrades predictably over distance (inverse-square law). However, in the exhibition space, the Raw RSSI 302a is highly volatile. It is subject to “multipath fading,” where signals bounce off walls and arrive at the antenna at slightly different times, causing constructive or destructive interference. It is also subject to “body shadowing,” where the user's own body blocks the line of sight between the phone and the beacon. Consequently, a single Raw RSSI reading 302a is insufficient to accurately determine if a user 12 is standing in front of an art installation or merely walking past it.

The second input 302b comprises the Beacon ID. This is a unique identifier (e.g., a UUID, Major, and Minor value in BLE protocols) embedded in the wireless signal 24. The Beacon ID 302b allows the proximity engine 300 to identify exactly which environmental feature 20 is broadcasting the signal. This identification links the generic signal to a specific physical context.

The third input 302c comprises Device Orientation data. This data is derived from the inertial measurement unit (IMU) of the user device 10, specifically the accelerometer and gyroscope. The Device Orientation 302c provides context regarding how the user 12 is holding the device 10. For example, the sensor data can distinguish between a device held upright in a hand (indicating active engagement/scanning) and a device inverted in a pocket or bag (indicating passive movement). This input helps the proximity engine 300 weight the signal readings. A signal received while the phone is buried in a backpack may be naturally attenuated by fabric and other objects, requiring a different interpretation than a signal received by a phone held out in the open.

The core logic of the proximity engine 300 utilizes these inputs to query a calibration database 310. The calibration database 310 stores the environmental calibration parameters associated with each unique Beacon ID 302b. These parameters represent the “ground truth” of the physical environment. For example, a specific record in the calibration database 310 might indicate that the beacon 22 associated with the “Emerson's Safe” installation is located inside a thick steel box. Steel is a material known to cause significant signal attenuation. Therefore, the calibration parameter for this Beacon ID includes a high attenuation factor.

When the proximity engine 300 processes the Raw RSSI 302a for the Safe, it applies this attenuation factor to normalize the signal. Effectively, the engine 300 determines that a weak signal from the Safe does not mean the user is far away. Rather, it means the user is likely close, but the signal is being suppressed by the metal. The engine 300 mathematically compensates for this suppression, boosting the calculated score. Conversely, a beacon 22 placed in a wooden structure might have a low attenuation factor, as wood is relatively RF-transparent.

The calibration database 310 may also store geometric constraints or “fingerprints” for triangulation. If the proximity engine 300 detects multiple Beacon IDs 302b simultaneously, it can utilize the known physical distance between these beacons (stored in database 310) to triangulate the user's precise location. This prevents “bleed-through” errors, where a strong signal from a beacon in Room A penetrates a thin wall and is detected by a user standing in Room B. By comparing the relative strengths of neighbors against the calibration map, the engine 300 can determine that despite the strong signal from Room A, the cluster of signals suggests the user is physically located in Room B.

Additionally, the proximity engine 300 applies smoothing algorithms (e.g., a Kalman filter or a moving average window) to the incoming data stream. This smooths out the jitter inherent in the Raw RSSI 302a. Instead of the proximity reading jumping erratically from “Far” to “Near” and back to “Far” every millisecond, the engine 300 produces a stable curve that reflects the user's actual physical approach vector.

The final output of the process may be the calibrated proximity score 320. Unlike the raw decibel reading, this score 320 is a normalized value (e.g., a confidence percentage from 0 to 100 or a calculated distance in meters) that accurately reflects the user's distance from the environmental feature 20, independent of the materials acting upon the signal. This calibrated proximity score 320 is the value passed to the threshold comparison logic (operation 250 in FIG. 2). By relying on the calibrated proximity score 320 rather than the Raw RSSI 302a, the system ensures that the unlocking triggers are consistent and reliable, regardless of whether the art installation is made of mesh, metal, wood, or glass.

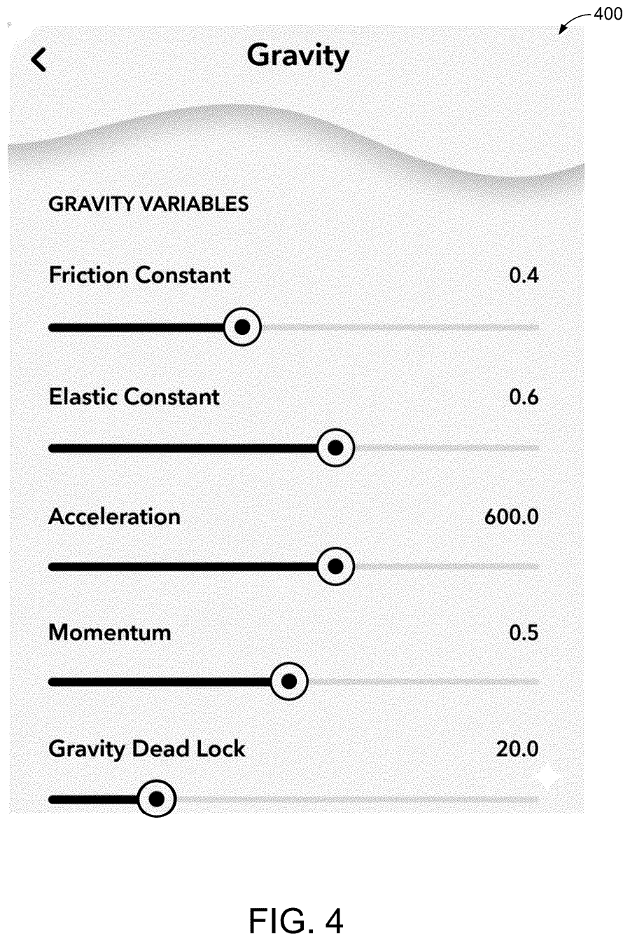

Referring now to FIG. 4, a diagram illustrates a physics configuration interface 400. As previously described, the graphical user interface (GUI) 30 of the user device 10 is designed to function not merely as a static menu of options, but as a simulated physical environment that reacts to the physical movements of the user 12. To achieve this, the data processing hardware 18 executes a physics engine (e.g., a rigid body dynamics simulation) that governs the behavior of user interface elements. FIG. 4 depicts the backend configuration parameters that define the laws of physics within this simulated environment. While these settings may be pre-configured by the content collection controller 150, in some implementations, they are accessible to the user 12 via a “Toys” or “Developer” settings menu (e.g., a hidden staff interface). Access to this interface may be triggered by a specific touch gesture, such as tapping a specific area of the screen (e.g., a settings header) five times with one finger, which generates a prompt for a four-digit PIN, allowing the user 12 or a staff member to customize the tactile feel of the application. Furthermore, this interface accepts specific state manipulation codes to facilitate testing and guest services. These codes may include location-specific identifiers (e.g., “0706” for a first location or “2706” for a second location), codes to toggle specific states (e.g., “Post-Visit” mode vs. “In-Exhibit” mode), or master codes to unlock all content for VIPs. This functionality also allows staff to bypass technical glitches (e.g., a non-functional beacon) by manually triggering unlocks to ensure guest satisfaction.

The physics configuration interface 400 includes a plurality of adjustable variables that serve as coefficients in the motion algorithms processed by the data processing hardware 18. A friction parameter control (labeled “Friction Constant”) defines the resistance to motion between the user interface icons and the virtual “surface” of the screen. A higher friction value causes icons to slide slowly and stop quickly when the device 10 is tilted, mimicking a rough surface like sandpaper, while a lower friction value causes icons to slide effortlessly, mimicking ice.

An elasticity parameter control (labeled “Elastic Constant”) defines the coefficient of restitution for collisions. This parameter governs how much kinetic energy remains after two UI elements collide or after an element strikes the edge of the screen. A high elastic constant results in a “bouncy” interface where icons rebound energetically off the screen bezels, whereas a low elastic constant results in a “dull” interface where icons thud against the walls and stop.

An acceleration parameter control determines a simulated gravitational force parameter (G-force) applied to the elements. This scalar value multiplies the vector data received from the device's accelerometer. By adjusting this simulated gravitational force parameter, the user 12 may simulate high-gravity environments (where icons fall heavily and rapidly toward the ground) or low-gravity environments (where icons float or drift).

A momentum parameter control allows for the adjustment of the conservation of momentum, influencing how long objects continue to move after the external force (tilt) stabilizes. A dead lock parameter control (labeled “Gravity Dead Lock”) defines a threshold for cessation of movement. Because accelerometers in mobile devices naturally produce a small amount of signal noise or “jitter,” a physics engine without a dead zone might cause icons to vibrate or “shiver” even when the device 10 is resting on a table.

The dead lock parameter establishes a minimum force value required to initiate or maintain movement. Forces below this threshold may be ignored, ensuring the interface remains visually stable when the device 10 is effectively stationary.

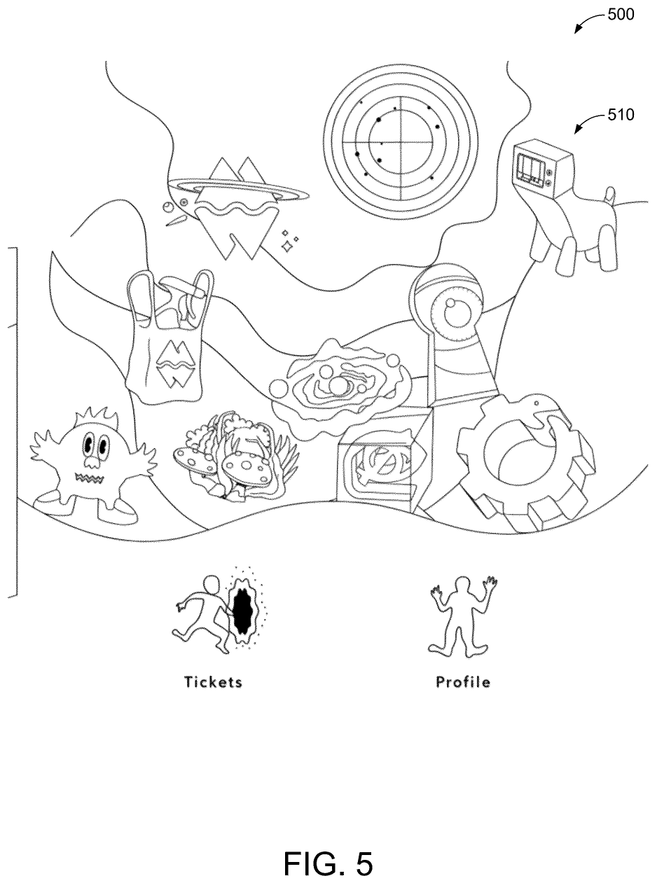

Referring now to FIG. 5, a diagram illustrates a tumbled home screen interface 500. This interface 500 represents the runtime execution of the physics engine configured in FIG. 4, reacting to real-time sensor data. In this view, the standard grid layout typical of mobile operating systems has been abandoned in favor of a dynamic, gravity-driven pile.

The interface 500 comprises a plurality of applet icons 510. Each applet icon 510 corresponds to a functional module of the system. Within the physics engine, each applet icon 510 is defined as a rigid body with specific dimensions, mass, and collision boundaries (hitboxes). The data processing hardware 18 continuously monitors the device orientation input 302c (described in FIG. 3). When the user 12 tilts the user device 10, the physics engine calculates a gravity vector relative to the screen.

Based on the detected orientation, the data processing hardware 18 animates a movement of the plurality of applet icons 510. As illustrated in FIG. 5, the icons 510 fall toward the “downward” edge of the device 10. They may not overlap. Instead, they may collide and stack upon one another based on the collision dynamics defined by the elasticity and friction parameters. If the user 12 were to rotate the device 10 ninety degrees clockwise, the icons 510 may tumble, slide, and bounce until they settled against the new bottom edge (formerly the left edge) of the screen.

This dynamic interface serves a dual purpose. First, it reinforces the narrative conceit that the app is a “living” artifact from another dimension rather than a static piece of software. Second, it encourages the user 12 to interact physically with the device 10, priming them for the physical exploration required by the Psychic Sensor (FIG. 2). Additionally, the interface 500 may include a parallax background layer (implied as the whitespace or illustrated background behind the icons). The content collection controller 150 may apply a “Spotlight” effect to this layer, where a simulated light source moves in opposition to the device tilt, creating a sense of depth and three-dimensionality behind the tumbling icons 510. In some examples, the intensity and behavior of this effect are user-adjustable. The user 12 may access a settings menu to modify a spotlight sensitivity parameter, defining how reactive the virtual light source is to the input from the gyroscope or accelerometer.

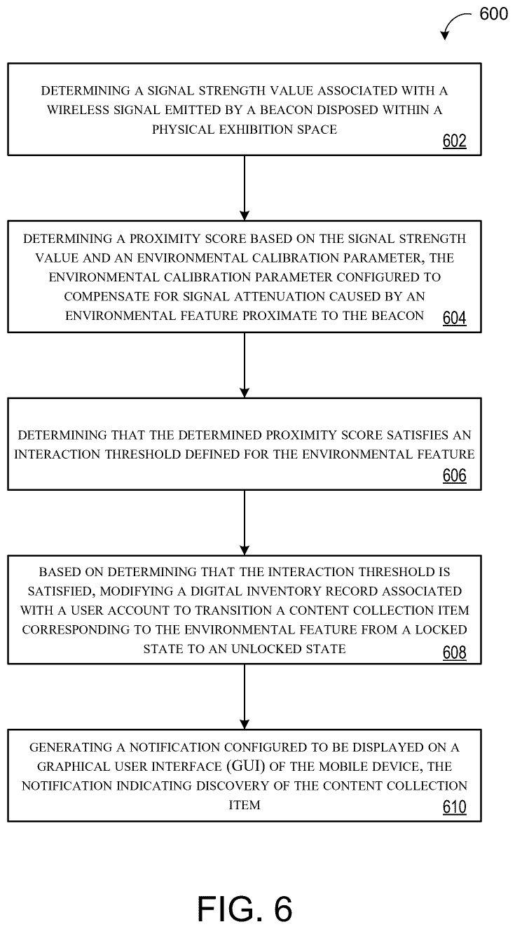

FIG. 6 is a flowchart of an exemplary arrangement of operations for a method 600 of determining location-based proximity in complex radio frequency (RF) environments. The method 600 is typically executed by data processing hardware 18 of a mobile user device 10, often under the instruction of the content collection controller 150. The method 600 begins at operation 602, which includes determining a signal strength value associated with a wireless signal 24 emitted by a beacon 22 disposed within a physical exhibition space. This wireless signal 24 is detected via a background scanning process, allowing the mobile device 10 to operate in a low-power, passive state without requiring the user 12 to actively engage with the device screen.

At operation 604, the method 600 includes determining a proximity score based on the signal strength value and an environmental calibration parameter. The environmental calibration parameter is configured to compensate for signal attenuation caused by an environmental feature 20 (e.g., a metal art installation) proximate to the beacon 22. This operation specifically addresses the technical deficiencies of RSSI-based location services, which often fail in environments with high signal interference. By integrating an environmental calibration parameter that accounts for physical material properties (e.g., metal, mesh, density), the method 600 transforms raw, noisy signal data into a high-fidelity proximity metric capable of distinguishing between mere presence in a room and specific interaction with an object.

At operation 606, the method 600 includes determining that the determined proximity score satisfies an interaction threshold defined for the environmental feature 20. This logic allows for granular control over the user experience, enabling different thresholds for different narrative contexts (e.g., a “General Proximity” threshold for entering a room vs. an “Interaction Proximity” threshold for examining a small detail). Based on determining that the interaction threshold is satisfied, the method 600 proceeds to operation 608, which includes modifying a digital inventory record 160 associated with a user account 148 to transition a content collection item corresponding to the environmental feature 20 from a locked state to an unlocked state. This state change persists the user's progress, effectively creating a “save state” for their physical exploration of the narrative space.

At operation 610, the method 600 includes generating a notification 32 configured to be displayed on a graphical user interface (GUI) 30 of the mobile device 10, the notification 32 indicating discovery of the content collection item. This notification mechanism serves to alert the user 12 only when a meaningful discovery has occurred, preserving their immersion in the physical environment.

The arrangement of operations described in method 600 provides technical advantages and represents an improvement over conventional location-based content delivery systems. By utilizing an environmental calibration parameter configured to compensate for signal attenuation caused by environmental features 20, the method 600 directly addresses the technical problem of RF interference in complex physical environments. Conventional systems relying solely on raw signal strength often produce false negatives in the presence of signal-blocking materials like metal or dense composites. In contrast, the implementation of method 600 allows the mobile device 10 to accurately determine proximity even when the beacon 22 is obscured by such materials, thereby improving the reliability and precision of the location determination logic. This enhances the ability of the computer system (the mobile device 10) to function as a precision sensor in environments where it would otherwise fail.

Moreover, the execution of these operations via a background scanning process that modifies a digital inventory record 160 without requiring active user input (e.g., scanning a QR code) improves the efficiency of the human-computer interaction. By passively collecting “inventory” based on physical presence, the system reduces the cognitive load on the user 12 and eliminates the friction of constantly unlocking the device 10 to perform manual scans. This background processing, combined with the targeted generation of notifications 32 only upon successful discovery, optimizes device power consumption by avoiding the need for the high-power display and camera modules to be active continuously. The resulting system effectively bridges the gap between physical exploration and digital narrative, providing a seamless and immersive user experience that is technically robust against the challenges of the physical environment.

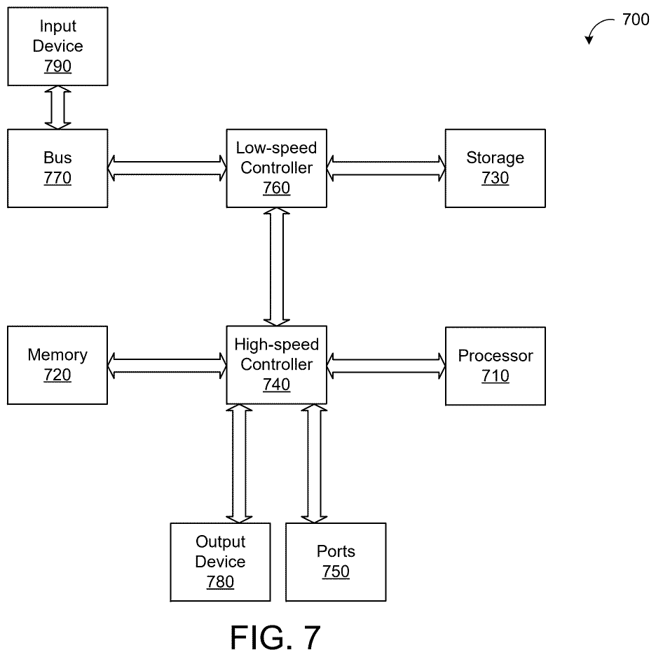

FIG. 7 is a schematic view of an example computing device 700 that may be used to implement the systems and methods described in this document. The computing device 700 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 700 includes a processor 710, memory 720, a storage device 730, a high-speed interface/controller 740 connecting to the memory 720 and high-speed expansion ports 750, and a low-speed interface/controller 760 connecting to a low-speed bus 770 and a storage device 730. Each of the components 710, 720, 730, 740, 750, and 760, are interconnected using various busses, and may be mounted on a common motherboard or in other manners as appropriate. The processor 710 can execute instructions for performing operations within the computing device 700, including instructions stored in the memory 720 or on the storage device 730 to display graphical information for a graphical user interface (GUI) on an external input/output device, such as display 780 coupled to high-speed interface 740. In other implementations, multiple processors and/or multiple buses may be used, as appropriate, along with multiple memories and types of memory. Also, multiple computing devices 700 may be connected, with each device providing portions of the necessary operations (e.g., as a server cluster, a group of blade servers, or a multi-processor system).

The memory 720 stores information within the computing device 700. The memory 720 may be a non-transitory computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 730 is capable of providing mass storage for the computing device 700. In some implementations, the storage device 730 is a non-transitory computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 720, the storage device 730, or memory on processor 710.

The high-speed controller 740 manages bandwidth-intensive operations for the computing device 700, while the low-speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port or input device 790. The low-speed expansion port 790, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 700 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more embodiments of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware of a mobile device that causes the data processing hardware to perform operations comprising:
determining a signal strength value associated with a wireless signal emitted by a beacon disposed within a physical exhibition space;
determining a proximity score based on the signal strength value and an environmental calibration parameter, the environmental calibration parameter configured to compensate for signal attenuation caused by an environmental feature proximate to the beacon;
determining that the determined proximity score satisfies an interaction threshold defined for the environmental feature;
based on determining that the interaction threshold is satisfied, modifying a digital inventory record associated with a user account to transition a content collection item corresponding to the environmental feature from a locked state to an unlocked state; and
generating a notification configured to be displayed on a graphical user interface (GUI) of the mobile device, the notification indicating discovery of the content collection item.

2. The method of claim 1, wherein the mobile device executes an application associated with the digital inventory record in a background state, such that the modification of the digital inventory record occurs without requiring user interaction with the GUI at a time of discovery.

3. The method of claim 1, wherein determining the proximity score comprises:
receiving signal strength values from a plurality of beacons disposed within the physical exhibition space; and
triangulating a position of the mobile device relative to the environmental feature,
wherein the environmental calibration parameter comprises an attenuation factor corresponding to a metallic composition of the environmental feature.

4. The method of claim 1, wherein:
the operations further comprise receiving an indication of a secondary user interaction associated with the environmental feature; and
wherein modifying the digital inventory record is based on receiving the indication of the secondary user interaction.

5. The method of claim 4, wherein the indication of the secondary user interaction comprises determining that the mobile device has detected an audio signature emitted by the environmental feature.

6. The method of claim 1, wherein the operations further comprise:
determining that the mobile device has exited a geographical area associated with the physical exhibition space; and
based on determining that the mobile device has exited the geographical area associated with the physical exhibition space, enabling access to a post-visit subset of the content collection item, the post-visit subset comprising a chronological narrative playlist.

7. The method of claim 1, wherein modifying the digital inventory record is further based on determining that the digital inventory record includes a requisite precursor item.

8. The method of claim 1, wherein:
the beacon is coupled to a mobile entity moving through the physical exhibition space; and
the interaction threshold is dynamically satisfied based on a changing location of the mobile entity relative to the mobile device.

9. The method of claim 1, wherein:
the operations further comprise receiving a confirmation signal from a sensor located at the environmental feature, the confirmation signal indicating presence of a physical token associated with the user account at the environmental feature; and
modifying the digital inventory record is performed further based on receiving the confirmation signal.

10. The method of claim 1, wherein:
the GUI comprises a home screen interface having a plurality of icons;
wherein the operations further comprise:
detecting an orientation of the mobile device; and
based on the detected orientation of the mobile device, animating a movement of the plurality of icons on the home screen using a simulated gravitational force parameter.

11. A system comprising:
data processing hardware of a mobile device; and
memory hardware in communication with the data processing hardware, the memory hardware storing instructions that when executed on the data processing hardware cause the data processing hardware to perform operations comprising:
determining a signal strength value associated with a wireless signal emitted by a beacon disposed within a physical exhibition space;
determining a proximity score based on the signal strength value and an environmental calibration parameter, the environmental calibration parameter configured to compensate for signal attenuation caused by an environmental feature proximate to the beacon;
determining that the determined proximity score satisfies an interaction threshold defined for the environmental feature;
based on determining that the interaction threshold is satisfied, modifying a digital inventory record associated with a user account to transition a content collection item corresponding to the environmental feature from a locked state to an unlocked state; and
generating a notification configured to be displayed on a graphical user interface (GUI) of the mobile device, the notification indicating discovery of the content collection item.

12. The system of claim 11, wherein the mobile device executes an application associated with the digital inventory record in a background state, such that the modification of the digital inventory record occurs without requiring user interaction with the GUI at a time of discovery.

13. The system of claim 11, wherein determining the proximity score comprises:
receiving signal strength values from a plurality of beacons disposed within the physical exhibition space; and
triangulating a position of the mobile device relative to the environmental feature,
wherein the environmental calibration parameter comprises an attenuation factor corresponding to a metallic composition of the environmental feature.

14. The system of claim 11, wherein:
the operations further comprise receiving an indication of a secondary user interaction associated with the environmental feature; and
wherein modifying the digital inventory record is based on receiving the indication of the secondary user interaction.

15. The system of claim 14, wherein the indication of the secondary user interaction comprises determining that the mobile device has detected an audio signature emitted by the environmental feature.

16. The system of claim 11, wherein the operations further comprise:
determining that the mobile device has exited a geographical area associated with the physical exhibition space; and
based on determining that the mobile device has exited the geographical area associated with the physical exhibition space, enabling access to a post-visit subset of the content collection item, the post-visit subset comprising a chronological narrative playlist.

17. The system of claim 11, wherein modifying the digital inventory record is further based on determining that the digital inventory record includes a requisite precursor item.

18. The system of claim 11, wherein:
the beacon is coupled to a mobile entity moving through the physical exhibition space; and
the interaction threshold is dynamically satisfied based on a changing location of the mobile entity relative to the mobile device.

19. The system of claim 11, wherein:
the operations further comprise receiving a confirmation signal from a sensor located at the environmental feature, the confirmation signal indicating presence of a physical token associated with the user account at the environmental feature; and
modifying the digital inventory record is performed further based on receiving the confirmation signal.

20. The system of claim 11, wherein:
the GUI comprises a home screen interface having a plurality of icons;
wherein the operations further comprise:
detecting an orientation of the mobile device; and
based on the detected orientation of the mobile device, animating a movement of the plurality of icons on the home screen using a simulated gravitational force parameter.
